(19) United States
(12) Patent Application Publication
(10) Pub. No.: US 2010/0017704 A1
(43) Pub. Date: Jan. 21, 2010

(54) DYNAMIC CONTENT LAYOUT

(75) Inventors: Chris Jaffe, Burlingame, CA (US); Keval Patel, Santa Clara, CA (US); JonDelina Denise Buckley, Alhambra, CA (US); Michael McElligott, San Francisco, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/175,771

(22) Filed: Jul. 18, 2008

(51) Int. Cl. G06F 17/00; G06F 3/01

(52) U.S. Cl. 715/243; 715/760

(57) ABSTRACT

Metrics for evaluating content layout performance are provided which enable the dynamic generation of content layouts optimized for particular target audiences, types of content, and/or delivery channels.

### BACKGROUND OF THE INVENTION

The present invention relates to the layout of content such as Web pages and, in particular, to techniques for dynamically generating such layouts.

One of the primary goals of content providers is to balance effectively the monetization potential of a medium with the presentation of content and the corresponding user experience. This has historically been the case for traditional print media, and is currently the case for Web pages. Unfortunately, the complexity of the problem and the large number of competing variables have made it difficult to either measure or systematically achieve such a balance.

At one extreme, a Web page may be designed with many ads in the hope that a user viewing the page will be likely to select one in response to the sheer volume. However, it turns out that this is not an effective approach in that it typically results in a relatively negative user experience which has a correlative effect on the monetization performance of the page. On the other hand, placing too few ads on a page results in missed monetization opportunities.

The lack of available tools and metrics for understanding the balance between monetization and user experience is further exacerbated by the inflexible nature of most Web page designs. That is, conventional Web page designs are relatively static in terms of the space allocated for advertising versus content. Unfortunately, such an approach to page design does not take into account the fact that the appropriate balance may be radically different for different users, content, etc.

### SUMMARY OF THE INVENTION

According to the present invention, techniques are provided for generating layouts for presentations of content. According to a particular class of embodiments, methods and apparatus are provided for presenting content requested by a user. One of a plurality of layouts is selected with reference to user data representing characteristics associated with the user, and with reference to content data representing characteristics of the content. Each of the plurality of layouts corresponds to one or more target audience profiles and one or more content profiles. The target audience profile to which the selected layout corresponds corresponds to at least a portion of the user data. The content profile to which the selected layout corresponds corresponds to at least a portion of the content data. The content and configuration data corresponding to the selected layout are transmitted for presentation on a device associated with the user.

According to another class of embodiments, methods and apparatus are provided for presenting content requested by a user. The user has user data associated therewith representing characteristics associated with the user. The content has content data associated therewith representing characteristics of the content. Presentation of the content on a device associated with the user is facilitated in accordance with configuration data representing a layout. The layout corresponds to one or more target audience profiles to which at least a portion of the user data corresponds. The layout also corresponds to one or more content profiles to which at least a portion of the content data corresponds.

According to yet another class of embodiments, methods and apparatus are provided for presenting content requested by a user. Presentation of the content on a device associated with the user is facilitated in accordance with configuration data representing a layout. The layout corresponds to a target audience profile representing the user. The layout also corresponding to a content profile representing the content.

According to still another class of embodiments, at least one computer-readable medium is provided having a plurality of data structures stored therein. Each data structure represents a corresponding content layout configured for one or more target audience profiles and one or more content profiles. Each data structure is configured to facilitate presentation of content represented by the one or more content profiles for which the corresponding content layout is configured that is requested by a user represented by the one or more target audience profiles for which the corresponding content layout is configured in accordance with the corresponding content layout.

According to a further class of embodiments, methods and apparatus are provided for evaluating performance of a web page. A first value is determined that represents interaction of a population of users with one or more regions of a plurality of instances of the web page. The one or more regions correspond to content of a particular type. A second value is determined that represents a portion of the web page corresponding to the particular type of content. A performance measure is generated for the web page using the first and second values.

According to yet a further class of embodiments, methods and apparatus are provided for developing page layouts for particular target audiences. Performance of each of a plurality of page layouts is evaluateed with reference to a plurality of target audience profiles and a plurality of content profiles. The performance relates to interaction of a population of users with pages presented in accordance with the page layouts. Each of the page layouts is assigned to one or more of the target audience profiles and one or more of the content profiles based on the performance evaluation. Presentation of content requested by users is facilitated using the page layouts assigned to the target audience profile corresponding to each of the users, and assigned to the content profile corresponding to the requested content.

A further understanding of the nature and advantages of the present invention may be realized by reference to the remaining portions of the specification and the drawings.

### BRIEF DESCRIPTION OF THE DRAWINGS

FIG. 1 is a simplified block diagram of a system for dynamically generating page layouts according to a specific embodiment of the invention.

FIG. 2 is a flowchart illustrating dynamic generation of page layouts according to a specific embodiment of the invention.

FIG. 3 is a simplified representation of a computing environment in which embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

As will be described, various embodiments of the present invention enable the generation and/or evaluation of layouts of content which may be optimized or targeted for particular audiences, types of content, distribution channels, etc.

In the context of web page layout, an appropriate balance between monetization and user experience may theoretically be achieved by the optimal number and/or placement of ads on the page. According to a particular class of embodiments of the present invention, metrics for evaluating and/or predicting the monetization performance of web pages are provided which enable the dynamic generation of web page layouts with reference to a particular target audience and/or a given set of circumstances, e.g., specific user, type of content, time of day, etc.

According to a specific embodiment of the invention, a particular metric referred to herein as “Revenue Per thousand Pixels,” or RPP, is introduced which may be used to evaluate, predict, and/or manipulate the monetization performance of web pages. It turns out that optimization of revenue for a given web page layout may be highly correlated with optimal user engagement. That is, where monetization opportunities are represented by ads, insertion of the right number of ads in the right places on the page will likely have the correlative effect of inclusion of the right amount of non-advertising content, thus resulting in improved user engagement with the page. Therefore, according to particular embodiments of the invention, it is possible to improve monetization of a web page while simultaneously enhancing user experience.

As will become apparent, RPP provides a more granular way to evaluate the monetization performance of a given page layout than previously possible. This is particularly important in view of the proliferation of “standard” ad sizes. Currently, there are anywhere from 70-100 different ads sizes which are commonly used on web pages ranging in size, for example, from very small, e.g., 24×24 pixels, up to roughly one-third of a web page. Given this multiplicity of ad sizes, simply evaluating performance by inserting and removing ads does not capture a significant amount of relevant information. By contrast, the normalization enabled by RPP enables a more nuanced and ultimately more effective approach.

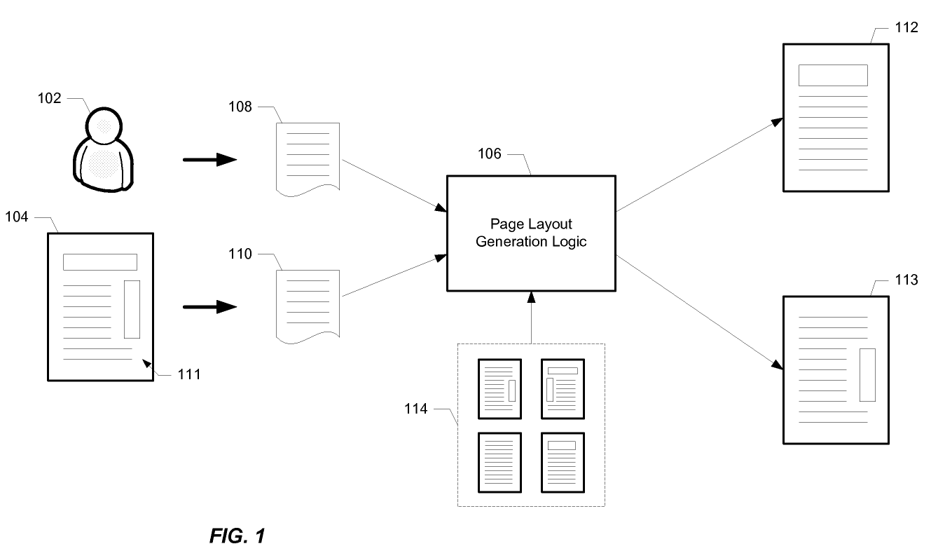

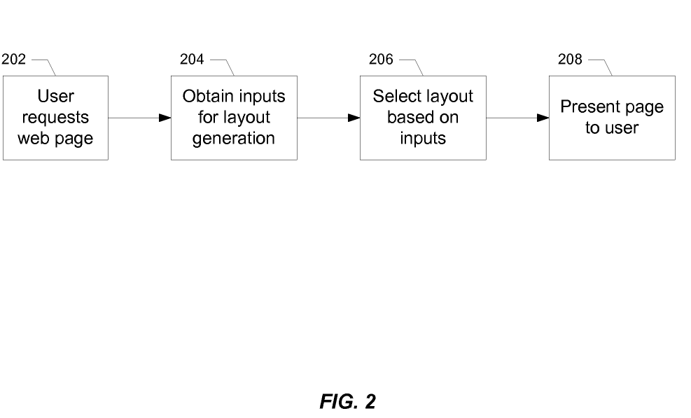

An example of a specific embodiment of the invention will now be described with reference to the flow diagram of FIG. 1 and the flowchart of FIG. 2. It should be noted that, while the following examples are described with reference to web page layouts, the present invention is not so limited. Rather, as should be apparent to those of skill in the art, embodiments of the invention may be employed for generating and evaluating layouts for any type of content representation or display of information delivered via any of a wide variety of channels.

In response to a request from user 102 for a web page 104 (202), input for generating a page layout is obtained for page layout generation logic 106 (204). In this example, the input includes at least two general categories of information. A first set of inputs 108 (generally referred to herein as user data) includes any of a wide variety of information relating to the user to whom the page is to be presented (or relating to a group or population segment to which the user belongs) including, for example, who the user is (e.g., user profile including expressed preferences), where the user is from (e.g., birthplace or current location), or any other demographic characteristics or attributes. According to some embodiments, this set of inputs may also include user engagement data representing the user's online behavior. This may include, for example, any data representing the user's browsing history, search history, interactions with content, advertisements, search results, etc. (potentially across multiple distribution channels). The time of day may also be an important input, as well as the season or time of year, and any of a variety of other temporal variables such as, for example, the average time spent on previous page(s), previous search(es), etc.

A second set of inputs 110 (generally referred to herein as content data) includes the attributes or characteristics relating to or associated with the page being laid out for presentation to the user, e.g., the source of the page (e.g., what web site), the size of the source (e.g., how large or small a site), the type of page (e.g., commercial, non-commercial, contextual, informational, etc.), type of content on the page (e.g., format and type including but not limited to text, images, video, animation, etc.), the country from which the page content originates or to which the page content is being served, etc. Another input may be what channel the content is being delivered through including, but not limited to, desktop computer, television, gaming device, cable television apparatus, mobile telephone or other mobile device, automobile information system, physical installation, etc. According to some embodiments, content module weighting might be included as input. That is, it is often the case that the publisher of a page intends to emphasize some content modules over others. Therefore, embodiments of the invention are contemplated in which weights are assigned to different modules to maintain such emphases in the generated layouts.

Based on these inputs, the page content 111 (e.g., ads, non-advertising content, etc.), and possibly other inputs as well (e.g., the type of channel through which the page is to be delivered, the time of day, a proportion of the content corresponding to a particular content type, the category of page content (e.g., community/social networking, news, political, etc.), etc.), one of a plurality of possible page layouts 114 is selected (206), and a page (e.g., 112 or 113) is instantiated using the selected layout and presented to the user (208). Each of the possible page layouts corresponds to one or more target audience profiles to which at least some of the user data are mapped. Similarly, each of the possible page layouts corresponds to one or more content profiles to which at least some of the content data are mapped.

According to specific embodiments, page layouts 114 are part of a set of preexisting layouts from among which a selection is made. Page layout information can be embodied in manual, pre-defined templates, or in real-time system-generated instructions as described below. According to the former embodiments, layouts 114 may initially be manually created with reference, for example, to data (e.g., market research, monetization performance (e.g., RPP), user engagement, etc.) which shows how particular population segments respond to particular layouts. According to the latter embodiments, the layouts may be dynamically generated by the system based, for example, on the inputs mentioned above as well as dynamic real-time data and various appropriate context-specific weighting factors or constants that could be added or modified in real time. Thus, when a specific type of user requests a specific type of page (possibly via a specific delivery channel), the system matches those inputs to a specific user experience as represented by a particular page layout.

Once created, a set of layouts (e.g., 114) (either manual or automatically originated) may then be evolved over time to take into account additional data representing the manner in which various population segments interact with the resulting pages. Such an evolution might involve, for example, the introduction of new layouts, the refinement of existing layouts, associating new layouts with existing or newly defined population segments, etc. And the evolution of the set of layouts may be facilitated in a wide variety of ways including, for example, using supervised or unsupervised machine learning techniques including, for example, the use of performance frequency counting, weighting models, or prediction algorithms. For example, some small percentage of pages presented in response to user requests may be devoted to experimental purposes. Such pages might include manual or automatically generated variations from the page layout(s) which would ordinarily be selected based on a particular set of inputs. User engagement data and/or page monetization performance data might then be used in conjunction with any of a variety of machine learning techniques to identify the page layout characteristics which correspond to desirable improvements, and to incorporate those characteristics into system operation.

According to specific embodiments, the development, optimization, and/or generation of page layouts may be guided using RPP, user engagement data, or any of a wide variety of measures of page performance. That is, such data may be used to optimize layouts, create new layouts, adjust population segments for which particular layouts are optimized, etc. As mentioned above, RPP is a particularly useful metric in evaluating the monetization performance of an interface, e.g., a web page, and so merits a more specific discussion.

Conventional metrics for evaluating monetization performance of web pages in the advertising context include, for example, click-through rate (CTR) and cost per million impressions (CPM). However, as mentioned above, these metrics are inadequate in certain respects in that they are difficult to normalize across the wide variety of potential ad sizes and placements. By contrast, the new metric introduced herein, RPP, provides a highly useful measure of monetization performance which has advantages over such conventional metrics.

According to a particular formulation relating to the context of advertising, RPP for a given page is derived by dividing the total advertising revenue for the page by the total number of pixels of the page devoted to advertising, and multiplying the result by a factor of a thousand. Of course it will be understood that the factor of 1,000 is somewhat arbitrary, and that other factors may be employed without departing from the scope of the invention. It will also be understood that there may be other formulations which are suitable. The basic idea is that, regardless of the shape, size, and number of ads on a page, the performance of a page may be evaluated with regard to the proportion of the content on the page which is devoted to advertising.

RPP enables evaluation of the performance of pages with the same number of pixels devoted to advertising content, but with different presentations (e.g., different numbers, sizes, and placements). This enables evaluation of the monetization performance of particular presentations relative to each other, as well as for particular target audiences and within the context of other factors such as content type, temporal factors, and delivery channels. Thus, embodiments of the present invention enable the identification of particular page layouts (e.g., the optimal number and/or placement of ads on a page) to which particular target audiences respond well.

For example, embodiments are contemplated in which RPP data may be used to identify the optimal ratio of advertising content to non-advertising content in a web page (e.g., as a ratio of ad pixels to total pixels in the page) for a particular demographic group (e.g., males between 45 and 60 years of age). When a user in that demographic requests a web page, the page may then be presented, not only with appropriate advertising content, but with the optimal percentage of the page devoted to advertising. As will be understood, RPP may be used to identify the optimal number of ads and/or the optimal placement on the page, as well as any of these in combination.

RPP is highly useful in contexts in which revenue is derived, but may not be as effective in cases in which page performance is represented by other metrics which may not be directly tied to revenue, e.g., user engagement with non-advertising content. Another metric is therefore proposed for measuring page performance in such contexts and is referred to herein as “Clicks Per thousand Pixels,” or CPP. As with RPP, CPP provides a different way of representing and evaluating how users respond to non-advertising content which is more granular than other conventional metrics, and enables the normalization of performance evaluation in a similar way. As will be understood, CPP may be used in any of the ways that RPP may be used.

In addition and according to various embodiments of the invention, RPP and/or CPP may be just one of a plurality of metrics employed to evaluate the performance of a page. That is, the use of RPP and/or CPP may be combined with the use of conventional metrics such as CTR and CPM to achieve a more nuanced understanding of how specific demographics respond to different page layouts, as well as to track page performance for any of a variety of purposes.

Moreover, the utility of the metrics RPP and CPP is not limited to selection or generation of page layouts as discussed herein. Rather, these new metrics may be used simply to track and report page performance for any of the wide variety of reasons that such tracking and reporting may prove useful. For example, an online advertiser might find this information useful in evaluating the performance of ongoing advertising campaigns as well as in determining how to allocate their advertising budget. In another example, online publishers might employ such metrics to determine how best to reach the audience in which they are interested, or how to present their content for different audiences. And as the Internet increasingly adopts open platforms for publishing content, advertising exchanges, and the like, metrics such as RPP and CPP are likely to become increasingly useful given their utility in normalizing and refining the data representing how users interact with the content presented to them in virtually any context. Those of skill in the art will understand the great variety of ways in which such metrics may be employed without departing from the scope of the invention.

According to some embodiments, the page content (e.g., 111) being laid out according to the invention corresponds to an original web page having a preexisting layout which is then modified in accordance with the particular implementation. Alternatively, some implementations may begin with the content 111 in a less structured format (e.g., raw text, image files, pointers to content, etc.), and then construct the page (or more generally information or content presentation) using the selected layout and the various content components.

According to a particular implementation, the selection of a particular page layout may entail a choice between one or more layouts optimized for particular population segments and some default layout. This might be useful, for example, where there is little or no information available about the particular user requesting a page, or the user doesn't map to any of the relevant population segments. In such cases, the default layout may be one of the available layouts in the system (e.g., layouts 114), or may be the original page layout where that is available. Similarly, the choice between a targeted layout and a default layout might be predicated on the particular delivery channel.

A wide range of variables may be considered when determining the types and placement of content in a web page according to various embodiments of the invention. For example, input relating to the user requesting a page (e.g., 108) may include any demographic information such as, for example, age, gender, geographic location, user engagement data (e.g., page views, browsing history, search history, advertising history, etc.), explicitly or implicitly expressed interests, etc. In addition, input relating to the page being requested (e.g., 110) may include, for example, the site of which the page is a part (e.g., Yahoo!, eBay, etc.), the country of origin, the type of content on the page (e.g., news, shopping, etc.), content-module weighting, etc.

Moreover, embodiments of the invention are not limited to the dynamic generation of layouts for content. That is, while dynamic generation of a layout is a very powerful and useful application of a “per pixel” metric, embodiments are contemplated in which a relatively static layout may be determined and then used on an ongoing basis. Such might be the case, for example, where page layouts are optimized on a periodic basis for a given demographic or target audience rather than each time a page is displayed.

Embodiments of the present invention may be employed in a variety of contexts. For example, an individual web site operator may employ techniques described herein to serve different layouts of its web page content to different segments of the population of users that visit the site, thereby enhancing user experience and/or improving the various monetization opportunities embodied in its pages. According to some embodiments, the techniques enabled by the present invention may be employed on larger scales to simultaneously enable layout generation across many domains. One example of such an implementation is in the context of an advertising exchange in which advertisers and publishers bid on graphical and search ad inventory available on the Web (i.e., not just from one provider). In such a context, embodiments of the present invention may be employed to facilitate optimization of publisher content which includes advertising delivered through the exchange. For example, the exchange could be configured to provide page layouts (e.g., in the form of templates or layout configuration code) to specific publishers which are optimized for the particular audience(s) each publisher has. This may be done in a relatively static way, e.g., pushing one or more layouts out to a publisher site which are then used to generate page layouts on an ongoing basis. It may also be done in a dynamic way, e.g., layout configuration information may be provided along with advertising content as users call up particular pages. In this way, an exchange operator could enhance the power of such an exchange by serving optimization code to publishers in a “one-to-many” way.

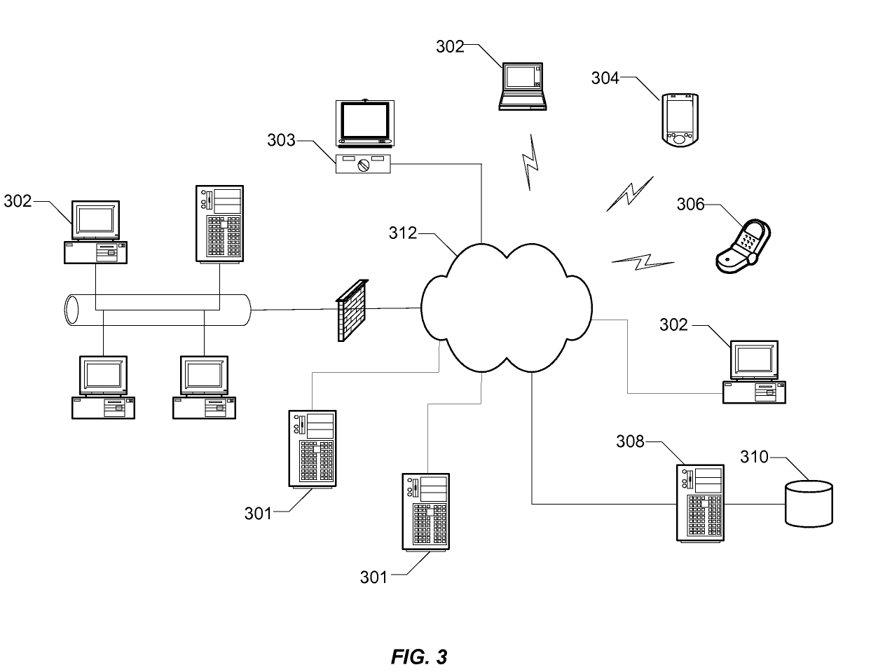

Embodiments of the present invention may be employed to develop, optimize, and/or generate layouts for content (e.g., web page layouts) in any of a wide variety of computing contexts. For example, as illustrated in FIG. 3, implementations are contemplated in which a population of users interacts with content publishers (e.g., web sites 301) via a diverse network environment using any type of computer (e.g., desktop, laptop, tablet, etc.) 302, media computing platforms 303 (e.g., cable and satellite set top boxes and digital video recorders), handheld computing devices (e.g., PDAs) 304, cell phones 306, or any other type of computing or communication platform. As will be understood, layouts created for presentation on any particular device or display type or channel may be optimized in accordance with the invention for presentation on any other device or display type.

Layouts generated according to the invention may be processed or provided in some centralized manner. This is represented in FIG. 3 by server 308 and data store 310 which, as will be understood, may correspond to multiple distributed devices and data stores. Alternatively, layouts may be generated according to the invention in a much more distributed manner, e.g., at individual web sites, or for specific groups of web sites. The invention may also be practiced in a wide variety of network environments including, for example, TCP/IP-based networks, telecommunications networks, wireless networks, etc. These networks are represented by network 312. Layouts generated in accordance with the invention may then be provided to users via the various channels with which the users interact with the network.

In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. For example, the present invention is not limited to generation of layouts for web pages presented on personal computers. Rather, the present invention may be employed to generate layouts for interfaces presented on mobile devices (e.g., cell phones and other handhelds), television, streaming video, etc. In addition, embodiments of the present invention are contemplated in which layouts are generated for print media, e.g., newspapers, magazines, etc. Embodiments of the invention may even be applied outside of the visual media context such as, for example, the sequencing and duration of various elements of audio content delivered via any of a variety of channels, e.g., radio, streaming audio, etc. Any context in which media may be configured for a particular audience segment (or even a specific user) may benefit from the present invention.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for presenting content requested by a user, comprising:
selecting one of a plurality of layouts with reference to user data representing characteristics associated with the user, and with reference to content data representing characteristics of the content, wherein each of the plurality of layouts corresponds to one or more target audience profiles and one or more content profiles, the target audience profile to which the selected layout corresponds corresponding to at least a portion of the user data, and the content profile to which the selected layout corresponds corresponding to at least a portion of the content data; and
transmitting the content and configuration data corresponding to the selected layout for presentation on a device associated with the user.

2. The method of claim 1 wherein each of the layouts represents an arrangement of advertising content and non-advertising content.

3. The method of claim 1 wherein the user data represent one or more of identity, age, gender, preferences, interests, a geographic location, user engagement data representing online behavior, browsing history, search history, interactions with content, interaction with advertisements, interaction with search results, or page view data.

4. The method of claim 1 wherein the content data represent one or more of a source of the content, a web site, a content publisher, a size of the source content, one or more content types associated with the content, a geographic area of origin, a geographic area to which the content is to be transmitted, or content module weighting.

5. The method of claim 1 wherein the selecting is done with reference to additional data representing one or more of a time of day, a type of channel by which the content is to be delivered, or a proportion of the content corresponding to a particular content type.

6. The method of claim 1 wherein each of the layouts has been optimized for the corresponding target audience and content profiles with reference to a performance measure determined with reference to interaction of a population of users with web pages presented in accordance with the layout.

7. The method of claim 6 wherein the performance measure comprises revenue per number of pixels on each of the web pages corresponding to a particular content type.

8. A computer-implemented method for presenting content requested by a user, the user having user data associated therewith representing characteristics associated with the user, the content having content data associated therewith representing characteristics of the content, the method comprising facilitating presentation of the content on a device associated with the user in accordance with configuration data representing a layout, the layout corresponding to one or more target audience profiles to which at least a portion of the user data corresponds, the layout also corresponding to one or more content profiles to which at least a portion of the content data corresponds.

9. The method of claim 8 wherein the layout represents an arrangement of advertising content and non-advertising content.

10. The method of claim 8 wherein the user data represent one or more of identity, age, gender, preferences, interests, a geographic location, user engagement data representing online behavior, browsing history, search history, interactions with content, interaction with advertisements, interaction with search results, or page view data.

11. The method of claim 8 wherein the content data represent one or more of a source of the content, a web site, a content publisher, a size of the source content, one or more content types associated with the content, a geographic area of origin, a geographic area to which the content is to be transmitted, or content module weighting.

12. The method of claim 8 wherein the layout further corresponds to one or more of a time of day, a type of channel by which the content is to be delivered, or a proportion of the content corresponding to a particular content type.

13. The method of claim 8 wherein the layout was optimized for the corresponding target audience and content profiles with reference to a performance measure determined with reference to interaction of a population of users with web pages presented in accordance with the layout.

14. The method of claim 13 wherein the performance measure comprises revenue per number of pixels on each of the web pages corresponding to a particular content type.

15. A computer-implemented method for presenting content requested by a user, comprising facilitating presentation of the content on a device associated with the user in accordance with configuration data representing a layout, the layout corresponding to a target audience profile representing the user, the layout also corresponding to a content profile representing the content.

16. At least one computer-readable medium having a plurality of data structures stored therein, each data structure representing a corresponding content layout configured for one or more target audience profiles and one or more content profiles, wherein each data structure is configured to facilitate presentation of content represented by the one or more content profiles for which the corresponding content layout is configured that is requested by a user represented by the one or more target audience profiles for which the corresponding content layout is configured in accordance with the corresponding content layout.

17. A computer-implemented method for evaluating performance of a web page, comprising:
determining a first value that represents interaction of a population of users with one or more regions of a plurality of instances of the web page, the one or more regions corresponding to content of a particular type;
determining a second value that represents a portion of the web page corresponding to the particular type of content; and
generating a performance measure for the web page using the first and second values.

18. The method of claim 17 wherein the first value is determined with reference to one or more of revenue, click-through rate, or number of views.

19. The method of claim 17 wherein the second value is determined with referenced to one or more of a number of pixels, a screen area, an interface area, or a proportion of the web page.

20. The method of claim 17 wherein the performance measure comprises revenue per thousand pixels.

21. A computer-implemented method for developing page layouts for particular target audiences, the method comprising:
evaluating performance of each of a plurality of page layouts with reference to a plurality of target audience profiles and a plurality of content profiles, the performance relating to interaction of a population of users with pages presented in accordance with the page layouts;
assigning each of the page layouts to one or more of the target audience profiles and one or more of the content profiles based on the performance evaluation; and
facilitating presentation of content requested by users using the page layouts assigned to the target audience profile corresponding to each of the users, and assigned to the content profile corresponding to the requested content.

22. The method of claim 21 wherein evaluating performance of each of the page layouts comprises:
determining a first value that represents interaction of a population of users with one or more regions of a plurality of instances of a first page corresponding to the page layout, the one or more regions corresponding to content of a particular type;
determining a second value that represents a portion of the first page corresponding to the particular type of content; and
generating a performance measure for the first page using the first and second values.

23. The method of claim 21 further comprising iterating the evaluating and assigning to optimize the page layouts for the target audience profiles and content profiles to which they are assigned.

24. The method of claim 23 wherein the iterating results in one or more of introducing new page layouts, refining existing page layouts, introducing new target audience profiles, refining existing target audience profiles, introducing new content profiles, refining existing content profiles, or establishing new associations among any of the new or existing page layouts, the new or existing target audience profiles, and the new or existing content profiles.
